(19) United States
(12) Patent Application Publication
(10) Pub. No.: US 2020/0250611 A1
(43) Pub. Date: Aug. 6, 2020

(54) TAMPER-RESISTANT ITEM TRANSPORT SYSTEMS AND METHODS

(71) Applicant: LOKI TECH LLC, San Diego, CA (US)

(72) Inventor: Shahriar POURTEYMOUR, San Diego, CA (US)

(21) Appl. No.: 16/377,107

(22) Filed: Apr. 5, 2019

Related U.S. Application Data
(60) Provisional application No. 62/800,226, filed on Feb. 1, 2019.

(51) Int. Cl. G06Q 10/08; A47G 29/14; G06F 9/54; G06F 16/909; H04W 4/029

(52) U.S. Cl. CPC G06Q 10/0832; G06Q 10/0833; A47G 29/141; A47G 2029/149; G06F 16/909; H04W 4/029; G06F 9/542

(57) ABSTRACT

Delivery of items has long been subject to degradation through pilfery, improper handling, or exposure to excessive environmental conditions. By providing items for delivery, or a mobile locker or secure container with the item for delivery, with an identifier readable and reportable by networked devices, custody of the item can be determined along with any degradation event. As a result, the providing source for the item and the receiving customers may be assured that the item delivered is provided in acceptable condition.

### CROSS-REFERENCE TO RELATED APPLICATIONS

This application claims priority to and benefit of U.S. Provisional Patent Application No. 62/800,226, filed Feb. 1, 2019, the entire contents of which are incorporated herein by reference.

### BACKGROUND

Delivery systems are now available for a variety of items, such as restaurant food items, medical supplies, pharmaceuticals, intoxicants, groceries, jewelry, precious metals, money, and other valuable items. While any item may be damaged or lost, certain items are particularly sensitive to degradation due to environmental conditions imposed by time, handling, pilfery, or adulteration. Additionally, degradation may be difficult to detect and, if detected, may only be determined after the opportunity to refuse delivery has passed.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompanied drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In an embodiment, a system includes a vessel configured to be moved during transport of an item contained within a containment area of the vessel; a sensor configured to produce sensor data that characterizes an environment proximate to the containment area; and at least one processor configured to: determine an event occurrence based on the sensor data; and send a notification to a device over a network in response to the event occurrence.

In an embodiment, a method includes receiving, from a sensor, sensor data that characterizes an environment proximate to a containment area of a vessel, wherein the vessel is configured to be moved during transport of an item located within the containment area; determining an event occurrence based on the sensor data; determining a custodian of the vessel during the event occurrence; and sending a notification indicating the custodian to a device over a network in response to the event occurrence.

In an embodiment, a non-transitory computer readable medium having instructions stored thereon, wherein the instructions, when executed by a processor, cause a device to perform operations comprising: receiving, from a sensor, sensor data that characterizes an environment proximate to a containment area of a vessel, wherein the vessel is configured to be moved during transport of an item located within the containment area; determining an event occurrence based on the sensor data; and determining a custodian of the vessel during the event occurrence.

In an embodiment, a secure vessel includes: a containment area; a sensor configured to produce sensor data that characterizes an environment proximate to the containment area, wherein the containment area is configured to be moved during transport of an item contained within the containment area; and at least one processor configured to: determine an event occurrence based on the sensor data; and send a notification to a device over a network in response to the event occurrence.

In an embodiment, a method performed by a secure vessel includes: receiving, from a sensor at the secure vessel, sensor data that characterizes an environment proximate to a containment area of the secure vessel, wherein the vessel is configured to be moved during transport of an item located within the containment area; determining an event occurrence based on the sensor data; determining a custodian of the vessel during the event occurrence; and sending a notification indicating the custodian to a device over a network in response to the event occurrence.

In an embodiment, a customer device includes: at least one processor configured to: send an order for an item to a source; receive a notification characterizing an event occurrence, wherein the event occurrence is based on sensor data that characterizes an environment proximate to a containment area of a secure vessel configured to be moved during transport of the item contained within the containment area; present an alert via a user interface in response to receiving the notification; and receive an instruction via the user interface in response to receiving the notification.

In an embodiment, a method performed by a customer device includes: sending an order for an item to a source; receiving a notification characterizing an event occurrence, wherein the event occurrence is based on sensor data that characterizes an environment proximate to a containment area of a secure vessel configured to be moved during transport of the item contained within the containment area; presenting an alert via a user interface in response to receiving the notification; and receiving an instruction via the user interface in response to receiving the notification.

In an embodiment, a source device includes at least one processor configured to: receive an order for an item from a customer; send a message to a courier to deliver the item based on the order; receive a notification characterizing an event occurrence, wherein the event occurrence is based on sensor data that characterizes an environment proximate to a containment area of a secure vessel configured to be moved during transport of the item contained within the containment area; and receive an instruction via the user interface in response to receiving the notification.

In an embodiment, a method includes: receiving an order for an item from a customer; sending a message to a courier to deliver the item based on the order; receiving a notification characterizing an event occurrence, wherein the event occurrence is based on sensor data that characterizes an environment proximate to a containment area of a secure vessel configured to be moved during transport of the item contained within the containment area; and receiving an instruction in response to receiving the notification.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention to facilitate the reader's understanding of the invention. Therefore, the drawings should not be considered limiting of the breadth, scope, or applicability of the invention. It should be noted that for clarity and ease of illustration these drawings are not necessarily drawn to scale.

FIG. 1A depicts a secure vessel delivery system in accordance with embodiments of the present disclosure.

FIG. 1B depicts a secure vessel, in accordance with embodiments of the present disclosure.

FIG. 2 depicts a first interaction in accordance with embodiments of the present disclosure.

FIG. 3 depicts a second interaction in accordance with embodiments of the present disclosure.

FIG. 4 depicts a third interaction in accordance with embodiments of the present disclosure.

FIG. 5A depicts an order process in accordance with embodiments of the present disclosure.

FIG. 5B depicts a delivery process in accordance with embodiments of the present disclosure.

FIG. 6 depicts a data structure in accordance with embodiments of the present disclosure.

FIG. 7 depicts a block diagram of an order to delivery process, in accordance with embodiments of the present disclosure.

FIG. 8 depicts a block diagram of a customer process, in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub-element identifier when a sub-element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

It is with respect to the above referenced issues and other problems that the embodiments presented herein were contemplated. Services are now available whereby items, such as food prepared by a restaurant, pharmaceuticals, intoxicants, medical supplies, groceries, jewelry, precious metals, money, and other high-value items, etc., may be picked up, transported, and delivered to the end-customer by a third party, such as Uber Eats™, DoorDash™, etc. However, problems may occur, as well as the perception of a potential problem, that hinders utilization.

If a delivery (e.g., a delivery of one or more items) is not delivered, then conventional means may be implemented, such as to notify affected parties, automatically or manually initiate a replacement, refund monies, etc. However, having an indication of who had control (e.g., custody) of the item when it became lost may be an important factor in determining fault for the missing item. Similarly, if a delivery is delivered to the end customer in a container (e.g., bag, box, etc.) and the container is damaged in such a way as to convey a reasonable impression that the contents are also damaged, the end-customer may take action, such as to require further inspection before accepting delivery or simply refusing delivery. Additionally, there may be situations where a product was improperly transported and is delivered to a customer who may not be able to readily identify (e.g., due to a lack of time for inspection) that the product was damaged due to improper transportation. Accordingly, identifying when the container, and items within, were likely damaged may be useful information for a customer to determine whether the customer should accept a delivered item, and generally for customer satisfaction with the item and the delivery. Also, identifying when the container, and items within, were likely damaged may be an important factor to ensure fault rests with only those who are at fault or who may have failed to take necessary steps to prevent the damage, hold the responsible party accountable, and/or implement remediations (e.g., discontinuing use of a particular driver or delivery service, refuse the ordered food item, drug item, or other type of item from a particular restaurant, refuse delivery beyond a certain distance, require special handling or transportation equipment, etc.).

For example, restaurant food may be received by an end-customer, who discovers that the food is in some way degraded. The temperature, size of the portion, absence of items, presence of other items, condition of the food, etc., may be the result of inappropriate handling or accidental or deliberate misrouting. The customer may express their dissatisfaction, but only knows for certain that the third-party delivered degraded food. The third-party may blame the restaurant and the restaurant may blame the third-party. It is also possible that the food arrived in as-expected condition and the customer, seeking unjust compensation, alleges some degradation. As a further example, such discovery of the degradation of the delivered food may be not be made immediately at the time of delivery, such as in situations where an end-customer may not have the time or resources to immediately inspect the delivered food at the time of delivery. Without a way to identify bad (or at least responsible) actors and/or eliminate known good actors, or to monitor integrity and facilitate the secure delivery of transported items, these transported items may continue to be subject to claims of degradation, whether or not degradation actually occurred or is merely alleged or suspected.

Accordingly, systems and methods are disclosed that describe a secure vessel delivery system for transport of an item or items such that custodianship of the secure vessel in which an item is contained may be tracked and evaluated. Examples of secure vessels may include, for example, containers and/or mobile lockers that will be discussed further below. These secure vessels may be configured to be moved during transport of an item located within a containment area of the secure vessel. Furthermore, the secure vessel delivery system may include a security sensor configured to produce sensor data that characterizes an environment proximate to the containment area (e.g., proximate to the secure vessel). In certain embodiments, a security sensor may be located directly on a secure vessel, such as when a security sensor on a vessel monitors for item degradation or unauthorized access to the item within the secure vessel. In further embodiments, a security sensor may be located off of a secure vessel. For example, the security sensor may be located on a user device (e.g., a courier device) configured to scan a tag on the secure vessel to change custodianship to and/or from a particular courier. In certain embodiments, the security sensor may be located on a source device and/or a customer device. For example, a security sensor on a source device may be an image sensor configured to take a first picture of an item immediately prior to a transfer of custody from the source device to the courier device. This first image may be sent to the customer device for verification or confirmation that the item is as expected. Also, a security sensor on a customer device (or a courier device) may be another image sensor configured to take a second picture of the item when delivered to the customer. Then, the first and second images may be compared to determine whether degradation or unauthorized access to the item within the secure vessel has occurred.

This sensor data may be evaluated to determine a status of the secure vessel and/or a custodianship of the secure vessel. For example, the sensor data may be evaluated to determine whether degradation or unauthorized access has, or is likely to have, occurred of an item under transport within the containment area. Accordingly, the sensor data may be utilized to monitor the integrity of the secure delivery of the item under transport within the containment area. The sensor data may also be utilized to identify the custodian of the secure vessel at the time when the degradation or unauthorized access may have occurred. In certain embodiments, the sensor data may be centrally processed via a data processing and storage system (e.g., a server and data store) in network communication with the security sensors of the secure vessel delivery system. However, in other embodiments, the sensor data may be locally processed, such as at a secure vessel or a user device (e.g., a customer device, courier device, and/or source device). Accordingly, tampering or degradation may be discouraged as a custodian of the secure vessel may be identified, and held responsible for any such tampering or degradation. Also, the secure vessel may be monitored for indications of such tampering and degradation during transport. These indications of such tampering and degradation may be communicated to an interested party for further processing and/or remediation.

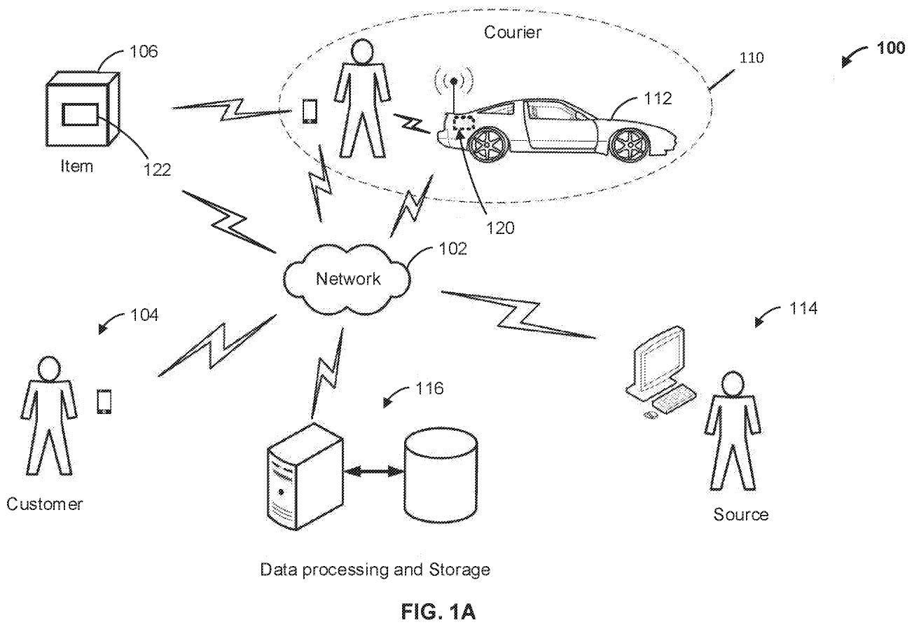

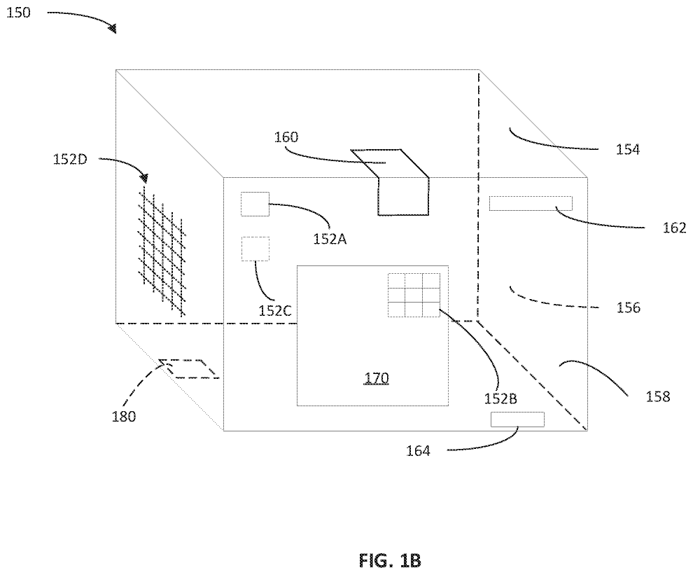

FIG. 1A depicts a secure vessel delivery system 100 in accordance with embodiments of the present disclosure. In one embodiment, a network 102 supports electronic communications between a plurality of devices, each equipped with a network interface. Network 102 may comprise one or more of wired or wireless networks, private networks (wired and/or wireless telephony), public networks (e.g., Internet), cellular mobile communication networks (e.g., the 3rd Generation Partnership Project (3GPP) 5^{th} generation New Radio (5G NR) communication networks) and/or other network or combinations thereof.

The secure vessel delivery system 100 is described in terms of electronic components having at least one processor, memory for the storage of data and instructions (e.g., hardware, firmware, removable, networked, etc.). While human actors are illustrated and may play a role in facilitating certain actions (e.g., holding a mobile phone or user device to capture an image via a camera security sensor on the mobile phone or user device, handling item 122, etc.), the role of any human is optional and provided merely as an aid to understand the figures. Furthermore, certain embodiments described herein are completely devoid of humans are involved and only automated systems are utilized in the manufacture/preparation, ordering, transporting, and receiving of item 122. In other embodiments, human involvement is limited to the role of facilitator for the systems and methods described herein. For example, a human may drive a vehicle 112, when vehicle 112 is embodied as a non-self-driving vehicle in response to navigation instructions provided by a navigation component of vehicle 112 to transport item 122 from source device 114 to customer device 104. However, when vehicle 112 is embodied as an autonomous or self-driving vehicle, the human may be omitted or provided merely as a backup operator, for legal compliance, or for the performance of other operations (e.g., physically carrying item 122 to/from vehicle 112, provide an input to a networked device, etc.). Although certain embodiments may reference the vehicle 112 as traversing a terrestrial path (e.g., over ground), the vehicle 112 may traverse any path across any medium as desired for different applications in various embodiments. For example, the vehicle 112 may be configured to traverse a path across air (e.g., as an airborne vehicle), water (e.g., as a waterborne or underwater vehicle), space (e.g., a space vehicle or spacecraft), or any other medium.

Customer device 104, comprises a networked computing device, such as a personal computer, mobile phone, laptop, tablet computer, etc., may place an order via network 102 for item 122 originating from source device 114. It should be appreciated that other techniques for customer device 104 to order an item 122 from source device 114 may also be utilized without departing from the scope of the disclosure. For example, item 122 may be a previously arranged delivery, such as a monthly subscription, gift subscription provided by another party not associated with customer device 104 but for delivery to the customer associated with customer device 104, etc. Similarly, the recipient of an order may also vary. For example, a data processing and storage system 116 may comprise an order taking application that receives and forwards the order to the source device 114.

Source device 114 is associated with a source for item 122. Item 122 may be produced by the source associated with source device 114 (e.g., manufacture, grower, restaurant, etc.) or merely available from the source associated with source device 114 (e.g., distributer, retailer, etc.). Source device 114 comprises a communication device with an interface to network 102. Additionally, source device 114 may comprise a number of networked components working in collaboration to comprise source device 114. For example, scanners, printers, encoders, etc.

A data processing and storage system 116 comprises a network interface to network 102 and may maintain records associated with the ordering, transport, and delivery of item 122 from the source associated with source device 114 to the customer, which may be associated with the current or future location of customer device 104. Data processing and storage system 116 may be dedicated or shared hardware, such as a computer, server etc., or a plurality of equipment that may be shared by multiple parties or users (e.g., “cloud” processing/storage, software-as-a-service (SaaS), server farm, etc.).

The item 122 may be placed in a secure vessel. Examples of a secure vessel include a human-portable container 106 (e.g., a bag, box, or other container for transport) or a mobile locker 120 (e.g., a secure vessel that is not human portable). In various embodiments, the container 106 or mobile locker 120 may be sealed (e.g., closed or locked) and unsealed (e.g., opened or unlocked). In various embodiments, reference to sealing a secure vessel may be inclusive of any manner of closing off a secure vessel from access to a containment area, whether physical (e.g., via locking a lock) or virtual (e.g., via an indication that access to the containment area is not authorized). Accordingly, a seal may represent any apparatus configured to indicate or enforce access to a containment area. Similarly, reference to unsealing a secure vessel may be inclusive of any manner of indicating that access to the containment area is allowed, whether physical (e.g., via unlocking a lock) or virtual (e.g., an indication that access to the containment area is authorized). The container 106 or mobile locker 120 may be lockable by a lock. When lockable, the container 106 or mobile locker 120 can include any type of lock, which may be integral to or separate from the container 106 or mobile locker 120. Additionally, the container 106 or mobile locker 120 can include at least one security sensor to monitor item 122 and/or the environment of item 122,a memory to store sensor data, and a network interface to transmit sensor data to another component, such as customer device 104 and/or source device 114. Security sensors may be used to monitor weight of the item 122, container 106 or mobile locker 120 as a function of time, orientation of the item 122, container 106 or mobile locker 120 during transportation, vibration or shock of the item 122, container 106 or mobile locker 120 during transportation or the state of the container 106 or mobile locker 120 (e.g., open/closed, occupied/empty, weight of contents) during transportation. Such security sensors may include, for example, any of a temperature sensor, an orientation sensor, a humidity sensor, a vibration sensor, a shock sensor, a location sensor, a tamper sensor, an image sensor, a proximity sensor, an electromagnetic connection detector, an air pressure sensor, and a user interface sensor. In certain embodiments, the container 106 or mobile locker 120 may include a communications interface to form a node on network 102 and serve as relay communications for components absent their own connection to network 102. In certain embodiments, a container 106 may be configured to be placed within a mobile locker 120.

A courier device 110 is variously embodied. In one embodiment, courier device 110 comprises a communication device, such as a smart phone, comprising a processor, memory, and network interface to network 102 and/or other network. Courier device 110 may also comprise other sensing equipment (e.g., security sensors), including but not limited to, camera, microphone, Global Positioning System (GPS) (or other satellite-enabled location) receiver, orientation, physical shock, temperature, barometric pressure, etc. Courier device 110 may physically carry or tow item 122, such as via a human using their hands or providing locomotion to a backpack, cart, wagon, etc. or a vehicle, such as vehicle 112, for item 122.

In various embodiments, courier device 110 may physically carry or tow a mobile locker 120 for transport of item 122. In another embodiment, courier device 110 comprises a vehicle 112 (e.g., where the courier device 110 is physically integrated with the vehicle 112 and/or represents a system that includes the vehicle 112). The vehicle 112 may be a bicycle, scooter, cart, wagon, automobile, truck, airplane, drone, boat, etc. and comprise mobile locker 120. Alternatively, item 122 may be carried in vehicle 112 and/or courier device 110 directly, that is, where the vehicle 112 and/or courier device 110 constitutes the mobile locker 120 (e.g., where the functions and processes of the mobile locker are integral or shared with the vehicle 112 and/or the courier device 110). Courier device 110 may also comprise a sub-network whereby two or more of mobile lockers 120, vehicle 112, courier device 110, and/or other devices, communicate. Additionally or alternatively, one of mobile lockers 120, vehicle 112, courier device 110, and/or other devices may form a node on network 102 and serve as relay communications for components absent their own connection to network 102.

The container 106 and/or mobile locker 120 may contain one or more items 122 for transport and delivery to the customer. In an embodiment, the container 106 or mobile locker 120 may be sealed (e.g., closed or locked) by the source device 114 and unsealed (e.g., opened or unlocked) locally and directly by the customer device 104 or remotely by source device 114 upon delivery (e.g., via pushing a button on a customer device to instruct the secure vessel to unseal).

In another embodiment, container 106 may have placed thereon directly a tag that may provide an indicia or identifier of an item 122 and/or vessel for transport of the item. The hardware of the tag may support an identifier that is visual (e.g., printed order number, type, description, etc.), near visual (e.g., infrared, ultra violet), and/or radio frequency (e.g., Near Field Communication (NFC), WiFi, cellular, GPS, Bluetooth, etc. or combinations thereof. For example, a customer device 104, source device 114 and/or courier device 110 may be configured to interact with the tag, such as by scanning or communicating with the tag via a security sensor on the customer device 104, source device 114 and/or courier device 110 in order to interact with a particular secure vessel and/or to transfer custodianship of the secure vessel. For delivery services, certain forms of communication are preferred over others due to issues such as a need for a subscription (e.g., cellular network access), high power requirements (e.g., GPS), additional hardware (e.g., line-of-sight antennas, etc.). Accordingly, and in another embodiment, an identifier may be provided to the courier device 110. Therefore, while the tag may communicate directly via network 102, additionally or alternatively, the tag may utilize another component or a component may receive the identifier and communicate via network 102 or other network (e.g., a security sensor on the security sensor on the customer device 104, source device 114 and/or courier device 110.

In another embodiment, container 106 may be sealed, such as with a security sensor that is a tamper resistant/tamper evident seal (e.g., a tamper sensor) such that any access to container 106 is deterred or, at least, likely to be detected by such a security sensor. As will be described in more detail below with respect to FIG. 1B, such tamper sensors may include an electrical mesh to determine whether a surface of the secure vessel has been opened or an electrical circuit configured to monitor the vessel has been opened during transport. For example, the tamper sensor may be two electromagnetic contacts that are weakly attracted to each other when in secure mode (e.g., as a normally closed circuit), and the physical separation of which (e.g., open circuit) produces sensor data that may trigger an alert (e.g., a sensor event). As another example, the tamper sensor may include detection of a beam (e.g., an infrared, laser, or other type of detectible emission) to indicate that there is no access to the containment area (e.g., that the secure vessel is closed) or not detected to indicate that there is access to the containment area (e.g., that the secure vessel is opened).

In further embodiments, a container 106 may utilize a security sensor to monitor container 106 or item 122 and/or the exterior and/or interior environment of container 106. For example, such a security sensor may include a sensor of temperature, orientation, vibration, shock, etc. and a memory to store and/or transmit sensor data to another component (e.g., vehicle 112, courier device 110) or directly or via such other components, notify source device 114, customer device 104, and/or data processing and storage system 116, of the sensor output data and/or a particular output data (e.g., data outside the range of acceptable or nominal values). In certain embodiments, a security sensor on the container 106 may include the tamper evident seal (e.g., where the seal is a tamper sensor that produces sensor data from which tampering of the container may be evident.).

In another embodiment, mobile locker 120 on the vehicle may comprise one or more compartments to contain the item 122 and/or container 106. The mobile locker 120 may comprise a network interface, memory, and a processor such that mobile locker 120 is required to receive a signal in order to seal (e.g., close or lock) and/or unseal (e.g., open or unlock) the mobile locker 120 or a particular compartment thereof. Additionally or alternatively, mobile locker 120 may comprise at least one security sensor to monitor container 106 and/or item 122 and/or the exterior and/or interior environment of container 106. Such a security sensor may sense, for example, temperature, orientation, vibration, shock, state of mobile locker 120 (e.g., open/closed, occupied/empty, weight of contents). Such a security sensor may also interact with a memory to store, and a network interface to transmit, sensor data to another component (e.g., vehicle 112, courier device 110) or directly or via such other components, notify source device 114, customer device 104, and/or data processing and storage system 116, of the sensor data and/or (e.g., data outside the range of acceptable values). In another embodiment, mobile locker 120 may have benefit of connectivity to vehicle 112 for communications, power, and/or data. For example, mobile locker 120 may be able to determine its location via a GPS signal from vehicle 112 or other user device (e.g., a smartphone) configured to provide a GPS signal and, if a current location matches a location associated with a delivery location (e.g., location of customer device 104), mobile locker 120 unlocks to allow extraction of container 106. When container 106 is implemented with a tag, mobile locker 120 may read/receive the identifier, such as via a camera, connectivity to another camera (e.g., a networked camera of courier device 110), WiFi, NFC, etc.

FIG. 1B depicts a secure vessel 150, in accordance with embodiments of the present disclosure. As noted above, the secure vessel 150 may be a human portable container in certain embodiments. In other embodiments, the secure vessel 150 may be a mobile locker. When the secure vessel is a mobile locker, the secure vessel may be integrated with a vehicle and/or courier device (e.g., physically attached with the vehicle and/or courier device).

In various embodiments, a secure vessel 150 may be physically integrated with at least one security sensor 152A, 152B, 152C, 152D. as will be described in more detail below The security sensors may be any type of sensor configured to produce sensor data that characterizes an environment proximate to a containment area of the secure vessel. The containment area may refer to an area of the secure vessel configured to contain an item during transport by the secure vessel. For example, the containment area may be an internal surface 156 accessible by opening a portal 154 (e.g., a door) of the secure vessel. The internal surface 156 (drawn in phantom) may contrast with an outer surface 158 directly exposed to an environment external to the secure vessel 150. In certain embodiments, the portal 154 may be opened upon opening a lock on the secure vessel 150. The lock may be, for example, an electromechanical lock that produces a latch (e.g., closes the portal) via a strong electromagnet, electrically rotating a padlock-style cylinder, or electrically sliding a metal bolt to close or open the portal. However, in other embodiments, the secure vessel 150 may not include a lock 160. For example, the secure vessel 150 may be sealed without a lock, such as where the secure vessel 150 may be closed or be associated with an indication (e.g., a notification in a user interface) that access to the containment area of the secure vessel is currently unauthorized. In various embodiments, components of the secure vessel 150 such as the security sensors 152A, 152B, 152C, 152D and the lock 160 may be powered by an internal power source 164 (e.g., a battery) that is part of the secure vessel 150. In further embodiments, the secure vessel 150 may include at least one local processor and memory to produce and/or analyze the sensor data from the security sensors. For example, the secure vessel 150 may be configured to operate with a network connection to a processing and storage system in certain embodiments and without the network connection to the processing and storage system in other embodiments.

In further embodiments, the secure vessel 150 may include a tag 162 which may indicate an identifier for the secure vessel 150 and/or an item for transport via the secure vessel 150. As noted above, the hardware of the tag may support an identifier that is visual (e.g., printed order number, type, description, etc.), near visual (e.g., infrared, ultra violet), and/or radio frequency (e.g., Near Field Communication (NFC), radio-frequency identification (RFID), WiFi, cellular, GPS, Bluetooth, etc. or combinations thereof. For example, a customer device, source device and/or courier device may be configured to interact with the tag, such as by scanning or communicating with the tag via a security sensor on the customer device, source device, and/or courier device in order to interact with the secure vessel 150 and/or to transfer custodianship of the secure vessel.

In certain embodiments, the security sensors 152A, 152B may be on an outer surface 158 of the secure vessel 150. By being on the outer surface 158, the security sensor may be directly exposed to an environment external to the secure vessel 150. As will be discussed in further detail below, the security sensor may be for example a user interface sensor 152B in which a user interface input may be received, for example. In further embodiments, security sensors 152D may be integrated within a surface of the secure vessel 150, such as a tamper sensor integrated within a surface of the secure vessel that includes an electrical mesh with a predefined pitch (e.g., 10 millimeters) that may change resistance upon being compromised. In yet further embodiments, the security sensor 152C may be on an internal surface 156 of the secure vessel 150. For example, as will be discussed further below, the security sensor 152C may be a temperature sensor configured to determine whether the contents of the secure vessel 150 is out of a desired temperature range (e.g., if a food item, drug item, or other type of item under transport is cold and no longer warm, or warm and no longer cold). In yet further embodiments, the security sensors may be implemented in a. single integrated module that may be removably attached to the secure vessel 150 (e.g., may be slipped into the secure vessel) so as to be movable between secure vessels 150 and/or replaceable in the event of failure.

In various embodiments, the security sensors may be, for example, any of a temperature sensor, an orientation sensor, a humidity sensor, a vibration sensor, a shock sensor, a location sensor, a tamper sensor, an image sensor, an air pressure sensor, and a user interface sensor. The temperature sensor may be configured to produce temperature sensor data. For example, the temperature sensor may be on the internal surface 156 of the secure vessel 150 to produce temperature sensor data indicative of a temperature within the secure vessel 150. This temperature sensor data may be utilized to determine whether the item (e.g., food, drugs, or other types of items) under transport may have become too warm or too cold during delivery.

In certain embodiments, the orientation sensor may be configured to produce orientation sensor data. For example, the orientation sensor may be an accelerometer (e.g. a 3 axis accelerometer) or a gyroscope to track orientation or movement of the secure package. This orientation sensor data may be utilized to determine that a package is mishandled, such as if the secure vessel 150 turns over during transport.

In certain embodiments, the humidity sensor may be configured to produce humidity sensor data. For example, the humidity sensor may be on the internal surface 156 of the secure vessel 150 to produce humidity sensor data indicative of a humidity within the secure vessel 150. This humidity sensor data may be utilized to determine whether the item under transport (such as food, drugs, or other types of items), may have become insufficiently or over humid during transport.

In certain embodiments, the vibration sensor may be configured to produce vibration sensor data. For example, the vibration sensor may be an accelerometer or other sensor that is configured to characterize vibrations experienced by the secure vessel 150. This vibration sensor data may be analyzed to determine whether vibrations experienced by the secure vessel 150 are over a threshold amount such that the item under transport by the secure vessel 150 was likely degraded or damaged due to excessive vibrations.

In certain embodiments, the shock sensor may be configured to produce shock sensor data. This shock sensor may be, for example, an accelerometer configured to determine whether a drop or impact (e.g., exceeding a threshold amount of acceleration or deacceleration in a set amount of time) has occurred with the secure vessel 150.

In certain embodiments, the location sensor may be configured to produce location sensor data. For example, the location sensor may be a GPS configured to produce location sensor data (e.g., GPS coordinates, relative location sensor data, and the like) from where a location of the secure vessel may be determined to identify whether the secure vessel has reached, or is properly in transit to reach, its intended destination (e.g., a reference location or reference geographic location). In further examples, the location sensor may be a relative location sensor that does not necessarily determine an absolute location (e.g., an absolute geospatial location, such as GPS coordinates) but produces relative location sensor data that characterizes a location relative to other devices or landmarks, such as a reference device. For example, the relative location sensor may be a frequency sensor (e.g., Near Field Communication (NFC), WiFi, cellular, Bluetooth, and the like) which may detect whether it is able to directly (e.g., not via an intermediary) communicate with a reference frequency sensor of a reference device to determine that it is within a communication range of the reference frequency sensor. Accordingly, the relative location sensor may be utilized to determine when the relative location sensor is within a particular relative location (e.g., within a communication range) of the reference frequency sensor of the reference device that denotes a desired or intended destination. For example, the relative location sensor may be utilized to determine when a relative location sensor associated with a courier device is within a particular communication range (e.g., is close to) of a reference frequency sensor of a reference device associated with an item to be transported or a customer to whom the item is to be delivered.

In certain embodiments, the tamper sensor may be configured to produce tamper sensor data. For example, the tamper sensor may include an electrical mesh with a predefined pitch (e.g., 10 millimeters) that may change resistance upon being compromised (e.g., in order to determine whether a surface of the secure vessel has been opened). As another example, the tamper sensor may be an electrical circuit configured to monitor the portal 154 to determine whether the portal 154 has been opened (e.g., when the electrical circuit is open and not closed) during an unauthorized time period (e.g., during transport).

In certain embodiments, the image sensor may be configured to produce image sensor data. For example, the image sensor may be an infrared sensor configured to produce infrared image data within the internal surface 156, which may be indicative of a temperature within the secure vessel 150. As another example, the image sensor may be configured to produce image sensor data indictive of light levels within the secure vessel 150, which could also be indicative of tampering.

In certain embodiments, the air pressure sensor may be configured to produce air pressure sensor data. For example, the air pressure sensor may be on the internal surface 156 of the secure vessel 150 to produce air pressure sensor data indicative of a temperature within the secure vessel 150. This air pressure sensor data may be utilized to determine whether the item under transport (such as food, drugs, or another type of item) may have been exposed to an environment with air pressure that is too low or too high.

In certain embodiments, the user interface sensor 152B may be configured to produce user interface sensor data. This user interface sensor data may be, for example, a keypad, biometric scanner, or other user interface that may be utilized to input an access pattern (e.g., a code of any number of digits, biometric pattern, electromagnetic pattern, and the like) to unseal (e.g., open or unlock) the portal 154 and/or to update custodianship of the secure vessel. In further embodiments, the portal 154 may be unsealed (e.g., the lock 160 may unlock or authorization otherwise granted to access an item within a containment area) when the input access pattern may be compared with a predetermined access pattern.

In various embodiments, the secure vessel 150 may include a user interface display 170. This user interface display 170 may be configured to display content, such as a logo or mark associated with the source device, information related to the order (e.g., a listing of contents of the secure vessel or an order receipt or confirmation), advertisements (e.g., a third party logo or a promotion for the item), and the like. In particular embodiments, a user (e.g., an agent associated with the source device, courier device, and/or customer device) may provide instructions or inputs to the user interface sensor 152B based on the content displayed within the user interface display 170. For example, the user interface display may provide content (e.g., a manifest of the one or more items within the secure vessel) that informs an agent of the customer device as to whether to enter an instruction via the user interface sensor 152 of acceptance or rejection of the delivered item. In particular embodiments, the content displayed on the user interface display 170 may be provided by the source device to the secure vessel for display on the user interface display 170. For example, the content may include third party content (e.g., an advertisement or promotion) that is provided by the source device for display on the user interface display. In further embodiments, the user interface display may encompass the user interface sensor 152B, such as where the user interface sensor is a portion of the user interface display. However, in alternative embodiments, the user interface display may be separate from the user interface sensor 152B. In various embodiments, reference to a generic user interface may reference either one of, or both the user interface sensor 152B and the user interface display 170.

In particular embodiments, the secure vessel 150 may include a docking port 180. This docking port may be an external interface for data and/or power transfer. This data transfer may refer to, for example, data transferred as related to a local processor of the secure vessel 150, the user interface sensor 152B, user interface display 170, a security sensor 152A, 152B, 152C, 152D, lock 160, tag 162, or any other component or part of the secure vessel 150. In addition, the power transfer may be, for example, power transferred to and/or from the internal power source 164 (e.g., battery) that is part of the secure vessel 150. In various embodiments, the docking port 180 may be part of a wireless external interface for data and/or power transfer to and/or from the secure vessel. For example, the docking port 180 may be configured to receive power from a wireless charging mat. In other embodiments, this docking port 180 may be part of a wired or other physical interface that may physically touch or otherwise interface (e.g., interlock) with an external device for data and/or power transfer to and/or from the secure vessel.

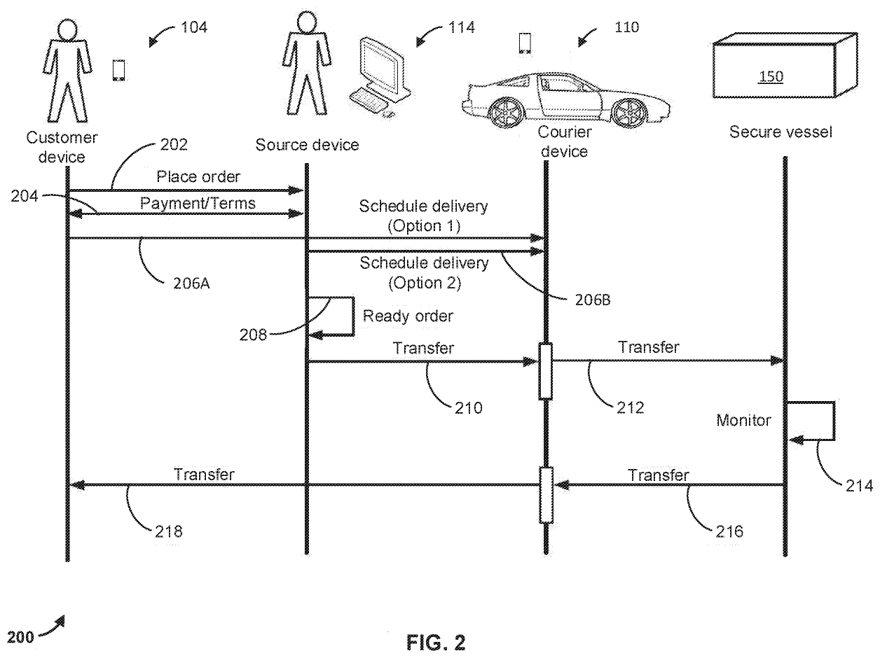

FIG. 2 depicts an interaction 200 in accordance with embodiments of the present disclosure. The interaction 200, or process, may be performed at a secure vessel delivery system, as introduced above. It is noted that the interaction 200 is merely an example, and is not intended to limit the present disclosure. Accordingly, it is understood that additional operations (e.g., steps) may be provided before, during, and after the interaction 200 of FIG. 2, certain operations may be omitted, certain operations may be performed concurrently with other operations, and that some other operations may only be briefly described herein.

In one embodiment, customer device 104 places an order in step 202 to source device 114. Additionally or optionally, customer device 104 and source device 114 perform steps 204 comprising payment and/or other terms of sale or delivery. Step 206 schedules delivery. Step 206A comprises customer device 104 arranging delivery directly with courier device 110. Alternatively, step 206B arranges delivery between source device 114 and courier device 110.

Step 208 readies the order. Step 208 may comprise any one or more of cooking, making, retrieving, packaging, and/or other steps to allow item 122 to be made ready for delivery. Step 208 may also comprise applying the tag to a secure vessel 150 (e.g., a container), which may further comprise the identifier. Step 208 may comprise locking the container to secure the item 122 from tampering.

Step 210 transfers the item 122 inside of the secure vessel 150 as a container or the secure vessel 150 as a mobile locker associated with courier device 110. Step 210 may comprise locking the mobile locker to secure the item 122 from tampering. In one embodiment, the source device 114 scans a tag on the secure vessel or otherwise receives the identifier, such as to create a record and/or facilitate custodianship of item 122 transferring to the courier device 110. Additionally or alternatively, the courier device 110 may scan the tag or otherwise receive the identifier as a record of the acceptance of the item 122. Step 212 may further communicate acceptance to the secure vessel 150 (e.g., as a mobile locker).

In some applications, the source device may retain custodianship of the item until departure of the item from a select spatial location. In this manner, the source device 114 (e.g., associated with a restaurant) can reopen the secure vessel 150 (e.g., as a container or a mobile locker) to correct an erroneous omission or inclusion of item(s). An electronic or digital custodianship token can be passed to the courier device indicating when the courier assumes custodianship for the item.

The secure vessel 150 (e.g., as a container or a mobile locker), as an optional portion of transfer step 212, may unlock, open, or otherwise enable acceptance of the item. Step 214 further includes monitoring one or more of the secure vessels 150 (e.g., as a container or a mobile locker), the item, and/or the exterior and/or interior environment of the secure vessel 150 (e.g., as a container or a mobile locker) and/or the item with one or more security sensors. Step 214 may also include receiving a signal to unlock, open, or otherwise allow removal of the item from the secure vessel 150 (e.g., as a container or a mobile locker). For example, the secure vessel 150 (e.g., as a container or a mobile locker) itself or via the courier device 110 may comprise a GPS receiver and, when associated with the delivery location, such as the location of customer device 104, unlocks or opens.

In another embodiment, the secure vessel 150 (e.g., as a container or a mobile locker) may comprise a memory and a sensor having biometric data associated with a human at the delivery location, such that when the sensor receives a compliant retina image, fingerprint, voiceprint, or other biometric data, container or mobile locker 120 unlocks or opens (e.g., via using a security sensor that is a user interface sensor configured to produce user interface data that is biometric data, as discussed above). In another embodiment, customer device 104 may initiate a signal, via network 102, to cause secure vessel 150 (e.g., as a container or a mobile locker) to unseal (e.g., unlock or open).

In another embodiment, the customer can have an application on customer device 104 that scans the tag (such as a QR code, RFID, or barcode) and, if the scanned image or value matches a tag image or value received by customer device 104 from source device 114, such as by text, email, SMS, etc., sends a message to the source device to unlock a lock or otherwise unseal to enable customer access to the contents of the secure vessel 150 (e.g., as a container or a mobile locker).

In another embodiment, a computational device (e.g., security sensor that is a user interface sensor) on secure vessel 150 (e.g., as a container or a mobile locker) can scan a tag displayed on customer device (previously provided, such as by text, email, SMS, etc., by source device 114) and, if the scanned image or value matches a tag image or value stored on computational device, unlock the lock on container 106 or mobile locker 120 or otherwise unseal the container 106 or mobile locker 120.

In another embodiment, the customer associated with the customer device 104 can be provided with a code, such as by text, email, SMS, etc., that when inputted by the customer into a physical or virtual lock keypad (e.g., security sensor that is a user interface sensor on the secure vessel 150) unlocks the lock on container 106 or mobile locker 120 or otherwise unseals the container 106 or mobile locker 120.

In another embodiment, source device 114 can send an unseal (e.g., unlock or open)signal to the computational device on the secure vessel 150 (e.g., the container or the mobile locker) when the customer confirms by text, email, SMS, etc., message transmission to the source device that the secure vessel 150 (e.g., the container or the mobile locker) has been delivered.

In another embodiment, the secure vessel 150 (e.g., the container or the mobile locker) can send an unseal (e.g., open or unlock) signal to a lock or seal on the secure vessel 150 (e.g., the container or the mobile locker) when the courier device 110 confirms by message transmission to the source device that the secure vessel 150 (e.g., the container or the mobile locker) has been delivered or arrived at the customer's destination. In certain embodiments, the customer's destination may be a predetermined destination, such as a set geospatial location or a location relative to an object (e.g., a customer device). As will be appreciated, other local and remote unlocking schemes can be envisioned to enable the customer to gain access to the contents of the secure vessel 150 (e.g., the container or the mobile locker). In further embodiments, the secure vessel 150 (e.g., the container or the mobile locker) can unseal when the courier device 110 confirms by message transmission to the source device that the secure vessel 150 (e.g., the container or the mobile locker) has been delivered or arrived at the customer's destination.

Unless already provided, step 216 signals courier device 110 that custodianship of item 122 has transferred to courier device 110, which in turns transfers custodianship to the customer associated with customer device 104 in step 218.

In another embodiment, step 214 monitors item 122 for indications of degradation. For example, secure vessel 150 (e.g., as a container or a mobile locker) may be opened via other means and, if the item is within but not proximate to the delivery location associated with the customer, such access may be unauthorized. Accordingly, the secure vessel 150 (e.g., as a container or a mobile locker) may report the unauthorized access to a customer device, source device, and/or a data processing and storage system. This reporting may be made via network communications, as discussed above. Additionally or alternatively, step 214 may determine that a degradation event has occurred. For example, the vessel 150 has been opened during transport, an item has reached an unacceptable temperature, been subject to excessive shock, turned upside down, etc. Accordingly, customer device 104 may then present the event in a user interface of the customer device 104, such that the recipient will have feedback about the security of the item that was transported. The customer device 104 can also provide the option to refuse delivery or receive other compensation if an item degradation event is detected. Furthermore, the source device 114 may be notified, such as to trigger re-execution of step 208 to prepare a replacement item 122 and signal the courier device 110 to divert from the current delivery and return to the source device 114 or signal a new courier device 110 to receive a replacement item.

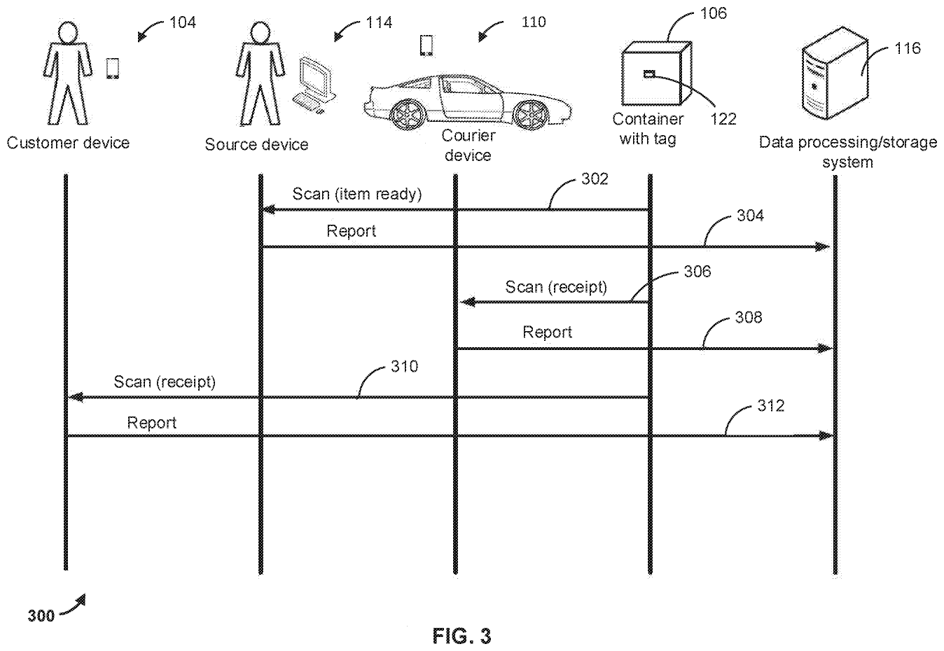

FIG. 3 depicts interaction 300 in accordance with embodiments of the present disclosure. The interaction 300, or process, may be performed at a secure vessel delivery system, as introduced above. It is noted that the interaction 300 is merely an example, and is not intended to limit the present disclosure. Accordingly, it is understood that additional operations (e.g., steps) may be provided before, during, and after the interaction 300 of FIG. 3, certain operations may be omitted, certain operations may be performed concurrently with other operations, and that some other operations may only be briefly described herein.

In one embodiment, interaction 300 omits utilization of a mobile locker and instead utilizes scanning by source device 114 of a tag on a container 106, or otherwise receiving of the identifier, in step 302. Source device 114 then reports possession of item 122 to a data processing and storage system 116 in step 304. The data processing and storage system 116 may create or update a record therein indicating that custodianship is presently with the source associated with source device 114.

Courier device 110 then scans the tag of container 106, or otherwise receives the identifier, in step 306. As noted above, this scan may be performed by a security sensor on the courier device 110, such as a barcode scanner or image sensor configured to produce sensor data (e.g., the scan). Step 308 reports the scan to the data processing and storage system 116. The data processing and storage system 116 may create or update a record therein indicating custodianship is presently with the courier device 110. At a later time, customer device 104 scans a tag of item 122, or otherwise receives the identifier, in step 310. Customer device 104 then reports possession of item 122 to the data processing and storage system 116 in step 312. The data processing and storage system 116 may create or update a record therein indicating custodianship is presently with the customer associated with customer device 104.

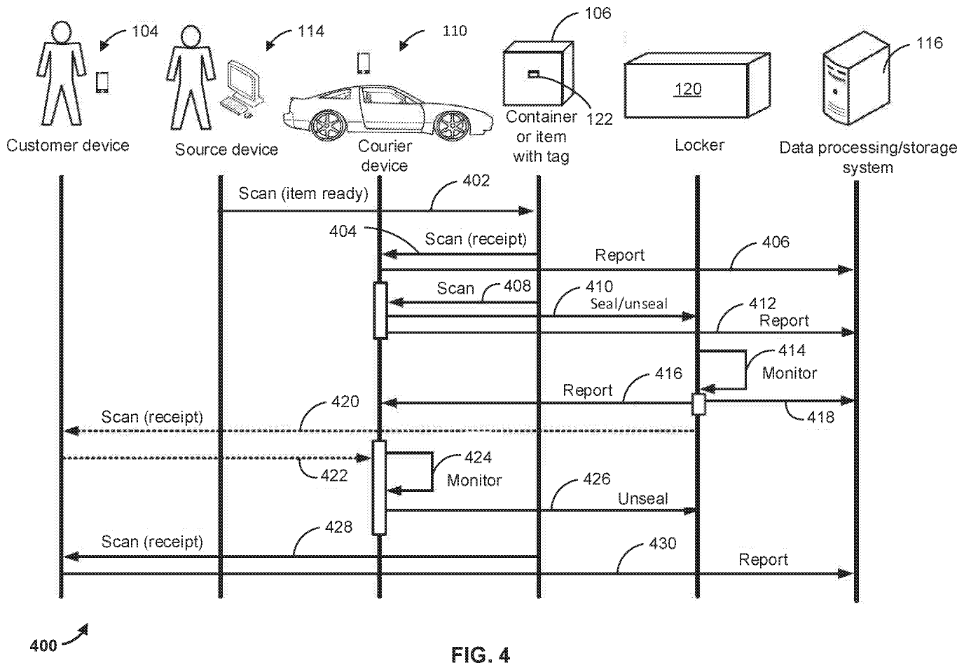

FIG. 4 depicts interaction 400 in accordance with embodiments of the present disclosure. The interaction 400, or process, may be performed at a secure vessel delivery system, as introduced above. It is noted that the interaction 400 is merely an example, and is not intended to limit the present disclosure. Accordingly, it is understood that additional operations (e.g., steps) may be provided before, during, and after the interaction 400 of FIG. 4, certain operations may be omitted, certain operations may be performed concurrently with other operations, and that some other operations may only be briefly described herein. Accordingly, interaction 400 may omit certain steps that are discussed elsewhere.

In one embodiment, interaction 400 utilizes for secure item transport a mobile locker 120 without the container 106 or container 106 without mobile locker 120. Stated another way, interaction 400 reflects alternate embodiments where only a single type of secure vessel is utilized, whether a container 106 or a mobile locker 120. In other embodiments, interaction 400 may reflect situations where both a container 106 and a mobile locker 120 are utilized. For example, the interaction 400 may reflect embodiments in which a container 106 is placed within a mobile locker 120.

The interaction 400 may begin when source device 114 scans the tag on the item 122, mobile locker 120, or container 106, or otherwise receives the identifier, in step 402. In step 404, a courier device 110 scans the tag, or otherwise receives the identifier, to indicate receipt of item 122. Also, the courier device 110 reports receipt to data processing and storage system 116 in step 406. A scan at step 408 may be implemented as a separate scanning event or combined with step 404 whereby mobile locker 120 and/or container 106 is/are signaled to seal (e.g., close or lock) or unseal (e.g., open or unlock) and report the seal/unseal (e.g., lock/unlock) event 410 to data processing and storage system 116. Also, the courier device 110 reports the scan to data processing and storage system 116 in step 412.

Accordingly, it should be appreciated that steps 404, 406, 408, 410, and 412 may occur at least twice, such as to receive an item from the source and once to remove item for final delivery. Additional iterations of step 404, 406, 408, 410, and 412 may also occur, however, they may be unauthorized or unexpected and cause data processing and storage system 116 to create an exception record and/or notify other parties, such as customer device 104, courier device 110, and/or source device 114. For example, the courier may have hit a pothole or otherwise have reason to believe that item 122 may no longer be suitable for delivery. As a result, inspection of the contents of mobile locker 120 and/or container 106 is/are initiated and an exception record created or updated. Accordingly, a record is made that the courier opened the mobile locker 120 and/or the container 106 and, should pilfery or adulteration of item 122 have occurred, the courier of the courier device may be investigated as the agent for the pilfery or adulteration. Similarly, if the receiving customer claims the item, when delivered, was pilfered or adulterated, it may be considered as more probable upon determining mobile locker 120 and/or container 106 was/were opened at an additional time in accordance with the exception record.

In another embodiment, a courier associated with the courier device 110 may not have authorization to open/unlock or close/lock the mobile locker 120 or container 106. For example, a signal may be required to open/unlock the mobile locker 120 or the container 106. As a result, the source associated with the source device may place the item 122 within the mobile locker 120 or the container 106, seal it (e.g., close it or lock it), and the customer associated with the customer device 104 may send a signal to cause the mobile locker 120 or container 106 to be unsealed (e.g., opened or unlocked) and constituent item retrieved therefrom. Accordingly, a claim of pilfery or adulteration would likely avoid suspicion falling on a courier associated with the courier device 110 when the mobile locker 120 or container 106 is enabled to detect opening events and none were detected.

The opening/closing or locking/unlocking as well as other conditions, such as those that may indicate the degradation of item 122, may be detected in monitoring step 414. For example, security sensors in a mobile locker 120, container 106, or courier device 110 may monitor one or more conditions that may indicate degradation of item 122. One or more of steps 416 and 418 may then report the output values of the sensor (e.g., raw values) and/or exceptions notification (e.g., when a raw value output by a sensor is outside an acceptable range). The results of monitoring step 414 may be reported to a courier device 110 in step 416 and/or to the data processing and storage system 116 in step 418., which can also report the results of the monitoring step to customer device 104

Optional step 420 occurs when customer device 104 scans a tag of mobile locker 120 or container 106, which may then allow mobile locker 120 or container 106 to open to enable retrieval of item 122 therein. Optionally or alternatively, the tag may be scannable (or the identifier otherwise obtainable) while within mobile locker 120 or container 106 while closed/locked (e.g., via a visible port enabling observation of a written identifier, transparent to radio transmissions, etc.). Also, upon the scanning event, the mobile locker 120 or container 106 may be unlocked, such as in step 426. Step 424 may monitor signals in addition, in alternate, or in coordination with step 414, such as to receive GPS signals, signals from the customer device 104 (e.g., step 422), or to receive other signals that may signal the mobile locker 120 or container 106 to unlock/open in step 426. In certain embodiments, the customer device 104, may scan tag or otherwise receive the identifier in step 428 and report receipt in step 430 to the data processing and storage system 116.

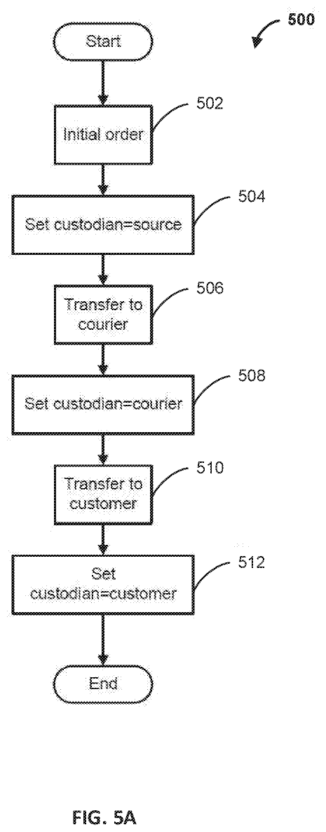

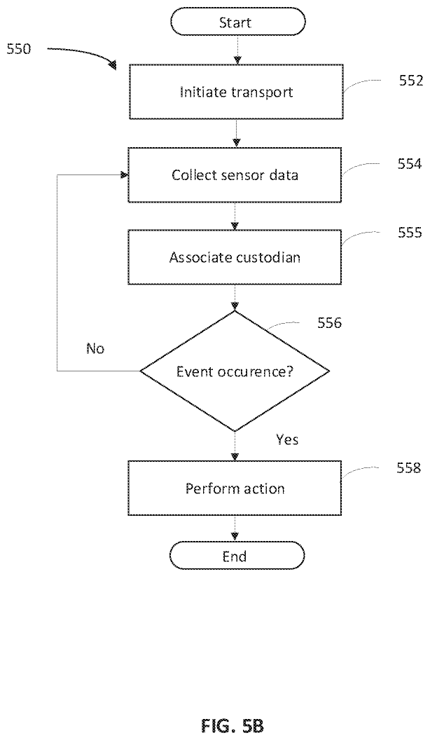

FIG. 5A depicts an order process 500 in accordance with embodiments of the present disclosure. The order process 500 may be performed at a secure vessel delivery system, as introduced above. More specifically, the order process 500 may be executed by one or more microprocessors, such as those of a data processing and storage system, source device, courier device, secure vessel, and/or customer device or a combination thereof. It is noted that the order process 500 is merely an example, and is not intended to limit the present disclosure. Accordingly, it is understood that additional operations (e.g., steps) may be provided before, during, and after the order process 500 of FIG. 5, certain operations may be omitted, certain operations may be performed concurrently with other operations, and that some other operations may only be briefly described herein.

The order process 500 may begin at step 502 with processing an initial order for an item to be delivered. Step 502 may comprise an electronic data structure being communicated between devices, such as between a data processing and storage system, source device, courier device, secure vessel, and/or customer device. A data structure may be created and/or modified that indicates the custodian of item is the source, such as an entity associated with source device. Step 506 transfers custody of the item to the courier, such as by a courier device scanning a tag on a secure vessel. In response, a data structure is created or modified to indicate custody has transferred to the courier in step 508. As noted above, in certain embodiments steps 506 and 508 may be repeated for respective couriers when custody is transferred among the multiple couriers. Step 510 transfers custody of the item to the customer, such as a party or agent associated with customer device 104. Step 510 may be provided by customer device 104 scanning a tag on the secure vessel. In response, a data structure is created or modified to indicate custody has transferred to the customer device in step 512.

FIG. 5B depicts a delivery process in accordance with embodiments of the present disclosure. The delivery process 550 may be performed at a secure vessel delivery system, as introduced above. More specifically, the delivery process 550 may be executed by one or more microprocessors, such as those of a data processing and storage system, source device, courier device, secure vessel, and/or customer device or a combination thereof. It is noted that the delivery process 550 is merely an example, and is not intended to limit the present disclosure. Accordingly, it is understood that additional operations (e.g., steps) may be provided before, during, and after the delivery process 550 of FIG. 5B, certain operations may be omitted, certain operations may be performed concurrently with other operations, and that some other operations may only be briefly described herein.

The delivery process 550 may begin at step 552. At step 552, transport of an item is initiated. This transport may be initiated by, for example, a customer device contracting with a source device for delivery of an item to a customer associated with the customer device. As part of this initiation, a courier associated with a courier device may be brought to receive the item from the source associated with the source device. Furthermore, to initiate delivery, the item may be deposited in a secure receptacle/vessel by either the courier associated with the courier device or the source associated with the source device and custodianship transferred from the source device to the courier device, as discussed above.

At step 554, sensor data may begin to be collected as the delivery process 550 is underway. For example, as soon as the courier receives the item and closes/locks the secure receptacle, a sensor signal indicating a sealed state (e.g., a closed state or locked state) of the secure receptacle may be collected. Additionally, the sensor data may characterize an environment proximate to a containment area of a secure .receptacle/vessel This containment area may be where an item under transport is secured or rests while undergoing transport via the secure receptacle. In certain embodiments, this sensor data may be produced by a security sensor that is part of a secure receptacle and/or is part of a courier device, source device, and/or a customer device. This sensor data may, for example, characterize a state of the item under transport (e.g., as image data of the item during transport or upon a transition of custodianship), characterize a change in custodianship (e.g., where a new custodian may, via a security sensor, scan a tag or otherwise indicate that the new custodian has taken over custodianship of the secure vessel), and/or characterize the transport of the item (e.g., where the sensor data may characterize how the item is being transported, such as the trajectory, handling, or state of the item under transport).

At step 555, a custodian may be associated with the collected sensor data. At least one custodian may be associated with every time period under which an item is being transported (e.g., via a continuous or semi-continuous series of timestamps). For example, this custodian may be a particular courier, associated with a courier device, that is undertaking the task of transporting the item within a secure vessel at a particular time. As noted above, the custodianship of a secure vessel may be handed off from a source device to a courier device once the item is placed within the secure vessel and the courier device confirms receipt of the item (e.g., by scanning a tag on a particular secure vessel or by otherwise updating a processing and storage system that custodianship has passed to a particular courier associated with a courier device). Also, there may be multiple custodians that facilitate delivery of a secure vessel containing an item from a source associated with a source device to a customer associated with a customer device. A more detailed discussion of how custodianship is changed and updated is provided above and is not repeated here for brevity.

At step 556, the sensor data may be evaluated to determine whether an event has occurred. In various embodiments, the event may be a predetermined pattern of sensor data that triggers an action. As noted above, the security sensors may be, for example, any of a temperature sensor, an orientation sensor, a humidity sensor, a vibration sensor, a shock sensor, a location sensor, a tamper sensor, an image sensor, an air pressure sensor, and a user interface sensor. Each of these sensors may produce respective sensor data that may be analyzed to determine whether a particular pattern in the sensor data triggers an event. The event may be detecting a signal from a tamper sensor that indicates that the seal of the secure receptacle has been opened or breached prior to delivery of the item or acknowledgment of receipt from a customer device or arrival at a GPS location matching the destination of the delivery of the item. Other events may be, for example, threshold values or patterns reached by sensor data values produced by respective security sensors. In certain embodiments, this sensor data may be further processed into a parameter value which may be evaluated against a threshold value (e.g., a predetermined pattern). For example, the threshold values may represent an outlier determined from aggregated sensor data of a respective type of security sensor, which when passed, may define an event. These outliers may be determined in accordance with conventional machine learning or statistical analysis for outliers. Accordingly, the event occurrence may be when the parameter value meets the threshold value. Additionally, each event may be cross referenced with a custodian associated with a time that the event has occurred (e.g., as there is a custodian associated with each time interval of item transport). Further discussion of exemplary events will be provided below. If an event has occurred, the process 550 may process to step 558. If no event has occurred, the process 550 may return to step 554.

At step 558, a corresponding action triggered by an event may be performed. For example, the action may be production of an unauthorized access alert in response to an event (e.g., of step 556) of unauthorized access to a secure vessel (e.g., sensor data meeting a pattern indicative of an unauthorized access, such as an unauthorized opening of a portal or breakage of a surface of the secure vessel during transport). This alert may be communicated to, for example, a user interface of a source device, courier device and/or a customer device that an unauthorized access has occurred to the secure vessel.

As another example, the action may be production of an item spoliation alert in response to an event (e.g., of step 556) of likely item spoliation in a secure receptacle (e.g., sensor data meeting a pattern indicative of an environment that would cause item spoliation, such as a temperature, humidity, or air pressure reading that is too high, too low, or otherwise outside of a nominal range). This alert or notification may be communicated to, for example, a user interface of a source device, courier device and/or a customer device that item spoliation has occurred at the secure receptacle.

As yet another example, the action may be production of an item mishandling alert in response to an event (e.g., of step 556) of item mishandling in a secure vessel (e.g., sensor data meeting a pattern indicative of item or secure vessel mishandling, such as a shock sensor indicating that an impact has occurred to the secure vessel or an orientation sensor indicating that the secure vessel is upside down or otherwise in an improper orientation). This alert may be communicated to, for example, a user interface of a source device, courier device, and/or a customer device that item mishandling has occurred at the secure vessel.

Although certain embodiments may reference an action to be an alert, further types of actions may be taken as desired for different applications in various embodiments. For example, the action may be an association of an alert with a custodian (e.g., a custodian's account in a centralized processing and storage system) of the secure vessel. In certain embodiments, this association may be due to being triggered at a time of a particular custodian's care (e.g., as associated with a particular custodian device) so as to easily identify which custodian is answerable to causing a particular alert. As a further example, the action may be using a data processing and storage system to associate an alert with an order, or account associated with a customer device, source device, and/or courier device. Additional actions may further be taken at the data processing and storage system, such as demeriting or crediting an account associated with a customer device, source device, and/or courier device should an event occur.

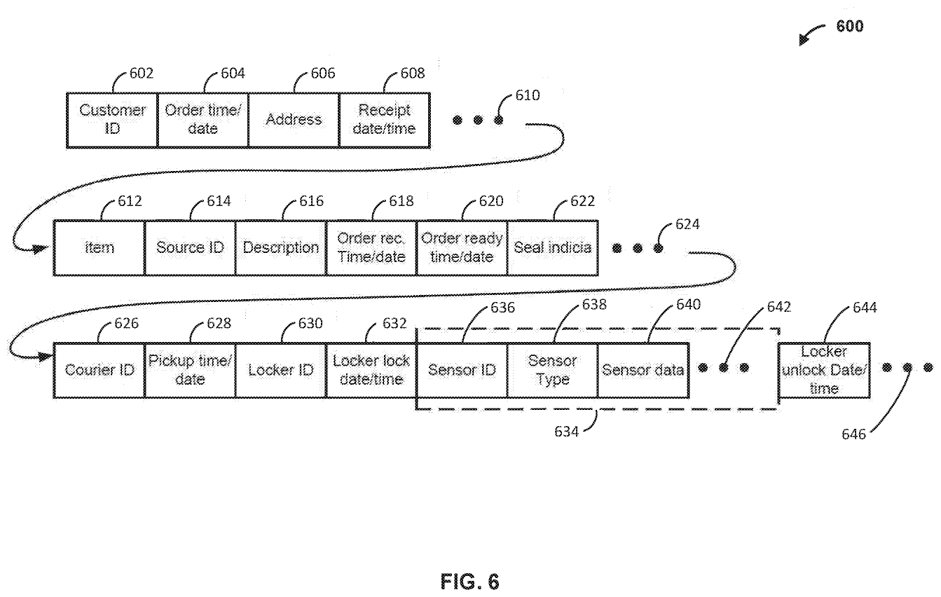

FIG. 6 depicts data structure 600 in accordance with embodiments of the present disclosure. In one embodiment, data structure 600 comprises a number of fields, which may themselves be data structures. Data structure 600 illustrate at least some of the data fields that may be maintained by a party, such as by a data processing and storage system. Data associated with the customer (party ordering item, party who will receive item, billing party and billing information, etc.) may comprise a customer identification field 602 (name and contact information of the customer), order time/date field 604, delivery address or location 606, receipt of item date/time field 608, and/or additional fields 610 as may selected as a matter of design choice.

Item field 612 may identify the item 122 (e.g., catalog number, item identifier, etc.), the source identifier field 514, description 515, order received date/time field 618, order ready for pickup date/time 620, seal identifier 622 (e.g., encoded description of a visual identifier, such as a QR code, RFID tag identifier, seal number, etc.), and other fields 624 as may be selected as a matter of design choice.

Courier identification field 616 may identify the courier for item 122 which was retrieved for pickup at the value of pickup date/time field 628. Locker 630 may identify the particular mobile locker and/or container and associated lock/unlock date time field 632. One or more sensor data structures 634 may be provided. Sensor data structure 634 may comprise a sensor identifier field 636 (e.g., for a security sensor), a sensor type field 638 (e.g., temperature, vibration, open-detection, etc.), and sensor data field 640 may maintain raw output values provided by a sensor (e.g., for a security sensor) and/or exception data (e.g., a temperature above a preset limit). Other fields 642 may also be implemented as a matter of design choice. Mobile locker or container 106 unseal (e.g., unlock or open) data/time 644 maintains the delivery time/date for item. Other fields 646 may be added for other purposes as a matter of design choice.

Data structure 600 may be utilized to identify issues associated with the delivery of item or a collection of items. For example, when sensor type field 638 is a GPS and the sensor data field 640 identifies a particular location on a route and another sensor type field 638 indicates a shock, the location may have potholes or other issues and an action taken to enable couriers to avoid such a location (e.g., via an alert to other courier devices to avoid a particular location). As noted above, in certain embodiments, the number or occurrences of the shocks (or other representation of sensor data indicative of the shock) may be compared with a threshold value to determine whether the event has occurred to trigger an associated action (e.g., production of an alert). This threshold value may represent an outlier determined from aggregated sensor data associated with shocks, which when passed, may define the event. These outliers may be determined in accordance with conventional machine learning or statistical analysis for outliers. In various embodiments, certain couriers and/or items may be determined to be problematic. For example, a restaurant providing item, such as soup, may arrive cold for customers beyond a certain distance. Accordingly, data structure 600 may determine what customers/items should be refused or at least notified and required to agree to the likely arrival condition of the particular item and/or additional precautions that may be required (e.g., heated compartment, heat packs, etc.).

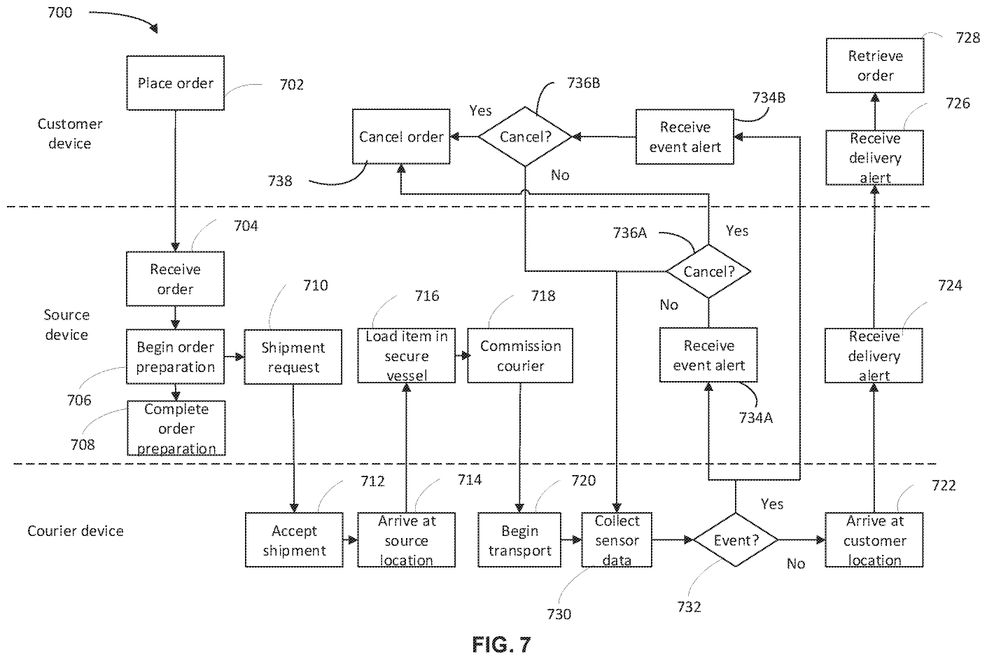

FIG. 7 depicts a block diagram of an order to delivery process 700, in accordance with embodiments of the present disclosure. The order to delivery process 700 may be performed at a secure vessel delivery system, as introduced above. More specifically, the order to delivery process 700 may be executed by one or more microprocessors, such as those of a data processing and storage system, source device, courier device, secure vessel, and/or customer device or a combination thereof. It is noted that the order to delivery process 700 is merely an example, and is not intended to limit the present disclosure. Accordingly, it is understood that additional operations (e.g., blocks) may be provided before, during, and after the order to delivery process 700 of FIG. 7, certain operations may be omitted, certain operations may be performed concurrently with other operations, and that some other operations may only be briefly described herein.

The order to delivery process 700 may begin at block 702. At block 702, a customer device may place an order on behalf of a customer. As noted above, this order may be for a particular item to be delivered to the customer. At block 704, a source device may receive the order placed by the customer device. As noted above, this order may be received at a source device from the customer device over a network.

At block 706, the source device may prepare the ordered item. By beginning to prepare the ordered item, the source device may make or send the appropriate instructions for a source (e.g., a restaurant) to prepare the order. As noted above, this may include preparing the item (e.g., food, drugs, or another type of item) to be delivered in accordance with the order. At block 708, the source device may note that the order is complete (e.g., the food, drug, or other type of item is ready for pickup).

At block 710, the source device may send a shipment request to a courier device. This shipment request may be a request for the courier device to transport the ordered item. This shipment request may be made based on the initiation of ordered item preparation in block 706.

At block 712, the courier device may receive and accept the shipment request from the source device. As noted above, the courier device may receive the shipment request via network communications with the source device. This shipment request may include information such as a source location for pickup of the ordered item and a customer location for delivery of the ordered item. In certain embodiments, the customer location may be a predetermined location, such as a set geospatial location or a location relative to an object (e.g., a customer device).

At block 714, the courier device may arrive at the source location. At block 716, the source device (e.g., via an agent of the source device) may load the item, whose preparation was completed in block 708, to a secure vessel./receptacle and seal/close/lock the secure vessel Secure vessels are discussed above and will not be further described here for brevity. In certain embodiments, the secure vessel may be provided by the courier device (e.g., by a courier associated with the courier device) to the source device (e.g., to an agent of the source device). In other embodiments, the secure vessel may be provided by the source such that the source device may be able to utilize the secure vessel (e.g., instruct an agent of the source to load the prepared item in the secure vessel) without having the secure vessel be provided by the courier device.

At block 718, the source device may commission the courier device to begin transport. This may entail the source device handing over custody of the secure vessel, inclusive of the ordered item, to the courier device for transport. In certain embodiments, the commissioning of the courier device may include instructing the courier device as to the customer location for delivery (e.g., as a confirmation of or instead of the customer location provided with the shipment request). At block 720, the courier device may begin transport of the secure vessel as commissioned by the source device and in accordance with the placed order. This transport may be from the source location to a customer location.

At block 730, sensor data may be collected from one or more security sensors during delivery or transport of the item. Details of sensor data collection are discussed further above and will not be repeated here for brevity. At block 732, a decision may be made as to whether an event has occurred based on the collected sensor data. Details of an event and/or whether an event has occurred are discussed further above and will not be repeated here for brevity. The order to delivery process 700 may proceed to block 722 if no event has occurred. Also, the order to delivery process 700 may proceed to blocks 734A and 734B in response to an event occurrence. In certain embodiments, the order to delivery process 700 may proceed to either one of block 734A or block 734B in response to an event occurrence.

At block 734A, a source device may receive an alert that the event has occurred. As noted above, this alert may be an action based on the event, such as an alert for presentation within a user interface of the source device. At block 736A, a decision may be made as to whether an instruction to cancel the order has been produced (e.g., made or input via the source device user interface) in response to the alert. The order to delivery process 700 may proceed to block 738 when an instruction to cancel the order is produced in response to the alert. The order to delivery process 700 may return to block 730 when an instruction to cancel the order is not produced in response to the alert.

At block 734B, a customer device may receive an alert that the event has occurred. As noted above, this alert may be an action based on the event, such as an alert for presentation within a user interface of the customer device. At block 736B, a decision may be made as to whether an instruction to cancel the order has been produced (e.g., made or input via the customer device user interface) in response to the alert. The order to delivery process 700 may proceed to block 738 when an instruction to cancel the order is produced in response to the alert. The order to delivery process 700 may return to block 730 when an instruction to cancel the order is not produced in response to the alert. At block 738, the order may be canceled. In certain embodiments, cancellation of the order may nullify the instruction for the courier device to transport the item to the customer location.

At block 722, the courier device may arrive at the customer location. By arriving at the customer location, the courier device may also bring or have transported the secure vessel with the ordered item to the customer location. Also, the arrival at the customer location may include a notification to the source device or the customer device as an alert that the courier device has arrived at the customer location. At block 724, the source device may optionally provide a delivery alert to the customer device indicating that the courier device has arrived at the customer location.

At block 726, the customer device may receive the alert that the courier device has arrived at the customer location. Then, at block 728, the customer device may note that the item has been retrieved (e.g., that the customer has retrieved the ordered item via the secure vessel at the customer location). Also, the customer device may note that custody of the item and/or secure vessel had passed to the customer device.

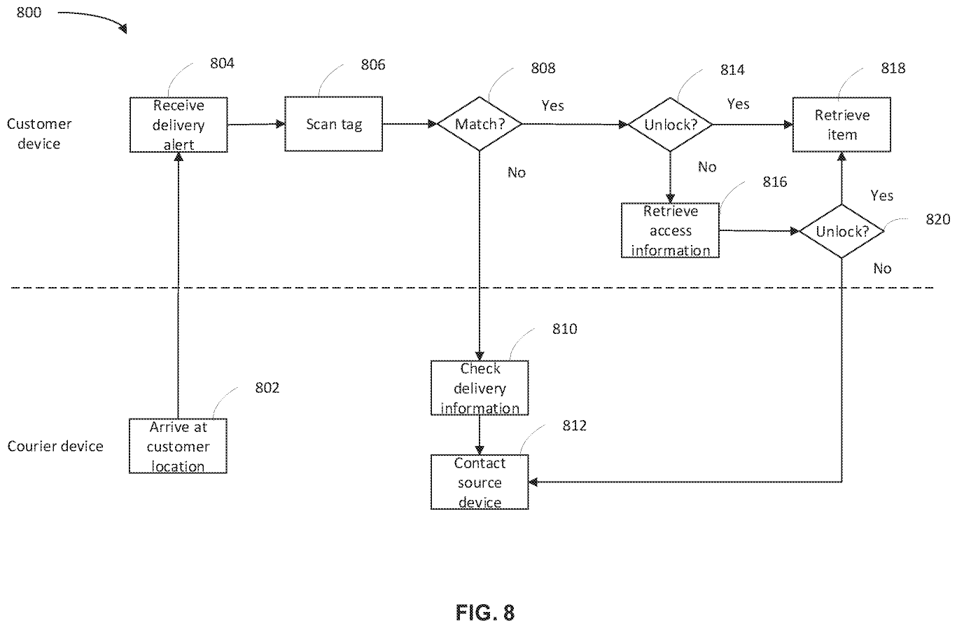

FIG. 8 depicts a block diagram of a customer process 800, in accordance with embodiments of the present disclosure. The customer process 800 may be performed at a secure vessel delivery system, as introduced above. More specifically, the customer process 800 may be executed by one or more microprocessors, such as those of a data processing and storage system, source device, courier device, secure vessel, and/or customer device or a combination thereof. It is noted that the customer process 800 is merely an example, and is not intended to limit the present disclosure. Accordingly, it is understood that additional operations (e.g., blocks) may be provided before, during, and after the customer process 800 of FIG. 8, certain operations may be omitted, certain operations may be performed concurrently with other operations, and that some other operations may only be briefly described herein.

The customer process 800 may begin at block 802. At block 802, a courier device may arrive at a customer location. In certain embodiments, block 802 may represent a continuation of the order to delivery process 700, such as from block 722. Returning to FIG. 8, at block 804, the customer device may receive a delivery alert that the ordered item is ready for pickup. As noted above, the ordered item may be within a secure vessel. Also, the secure vessel may include a tag that includes an identifier for the item, order, and/or secure vessel brought to the customer location. Details of secure vessels and tags are discussed further above and will not be repeated here for brevity. At block 806, the customer device may scan the tag. By scanning the tag, the customer device may receive the identifier for the item, order, and/or secure vessel brought to the customer location. At block 808, a decision may be made at the customer device as to whether the identifier from the tag matches an expected identifier for the item, order, and/or secure vessel brought to the customer location in accordance with the order. If there is a match, the process 800 may proceed to block 810. If not, the process 800 may proceed to block 814.

At block 810, the courier device may check delivery information. This check may set up providing the delivery information to the source device, as will be discussed further below. This check may also, or alternatively, be to make sure that the courier device's delivery of an ordered item to the customer location and/or to the customer device was not erroneous. At block 812, the courier device may contact the source device to remedy any issues from the delivery. For example, the courier device may contact the source device to remedy the issue of the identifier from the tag not matching an expected identifier for the item, order, and/or secure vessel brought to the customer location in accordance with the order. As another example, the courier device may contact the source device to remedy an issue of a lock on the secure vessel not unlocking.

At block 814, a decision may be made as to whether a first attempt to unseal (e.g., open or unlock) the secure vessel is successful. This first attempt may be made based on a confirmation that the identifier from the tag matches an expected identifier for the order item, order, or secure vessel brought to the customer location. For example, this first attempt may be automatic based on the match, referenced above in block 808. If the first attempt to unseal (e.g., open or unlock) the secure vessel is not successful, the process 800 may proceed to block 816. If the first attempt to unseal (e.g., open or unlock) the secure vessel is successful, the process 800 may proceed to block 818.

At block 816, the customer device may retrieve access information for manually unlocking the secure vessel. For example, this manual unlocking may entail entering access information (e.g., an access code of any number of digits (e.g., 6 digits) or any other unique information configured to grant selective access) on a user interface security sensor on the secure vessel itself, as discussed above. In certain embodiments, this access information may be received at the customer device in response to an unsuccessful first attempt to unseal (e.g., open or unlock) the security vessel. For example, this access information may be received via a text message from another component of the secure vessel delivery system (e.g., from a data processing and storage system, secure vessel, or source device via a network connection).

At block 820, a decision may be made as to whether a second attempt to unseal (e.g., unlock or open) the secure vessel is successful. This second attempt may be made based on the manual unlocking via provided access information discussed in block 816. If the second attempt to unseal (e.g., unlock or open) the secure vessel is not successful, the process 800 may proceed to block 812. If the second attempt to unseal (e.g., unlock or open) the secure vessel is successful, the process 800 may proceed to block 818. At block 818, the customer device may note that the item has been retrieved (e.g., that the customer has retrieved the ordered item via the unlocked secure vessel at the customer location). Also, the customer device may note that custody of the item and/or secure vessel had passed to the customer device.

In various embodiments, a secure vessel delivery system can enable courier tracking and characterization. For example, the routes taken by various couriers associated with respective courier devices from a given item source to a selected destination over multiple item orders can be used to identify and select, from among multiple courier devices, the more effective and timely couriers for a given item delivery to the selected destination. Ratings can be assigned to the courier devices based on his or her relative or comparative performance or customer satisfaction levels. A customer device associated with a customer or a source device associated with a source can select a higher rated courier device, from among multiple courier devices, for a given item order. Customer devices can be charged higher amounts for the use of a higher rated courier. More effective or faster routes from a given source to the selected destination can be identified based on the tracking of the various courier devices carrying item orders to the selected destination.

In various embodiments, the secure vessel delivery system can enable item tracking and characterization. For example, the handling or opening/closing history of a secure vessel holding the item can be tracked using feedback from the security sensors. For instance, the weight of the item can be tracked as a function of time to ensure that nothing has been removed from or added to the secure vessel during transportation.

The secure vessel delivery system can provide novel methods to charge customers for the courier service. A data processing and storage system could communicate with a secure vessel (e.g., the mobile locker or container) and be in control of the locking and unlocking functions at a secure vessel. The mobile locker or container could be provided to a source associated with the source device at little or no charge with a transaction charge being made to the source for each instance of locking or unlocking or on a locking/unlocking transaction-by-transaction basis. Due to the secure custodianship of the item, the source device (e.g., the source associated with the source device) could receive a reduced insurance charge from an insurance company for insuring the item delivery by a courier associated with the courier device. As will be appreciated, the reduced charge is the result of the lower item tampering or theft or loss risk resulting from more secure custodianship arising from the measures taken by the secure vessel delivery system. Although certain embodiments may have described delivery of items in the context of delivery of food items, any type of item may be delivered as desired for different applications in various embodiments. For example, further embodiments contemplate the delivery of items such as pharmaceuticals, intoxicants, medical supplies, groceries, jewelry, precious metals, money, and the like.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose microprocessor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A microprocessor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, datastore etc.) specific set of instructions selected from the platform's native instruction set.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a microprocessor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known to as “the cloud,” but may include a public, private, dedicated, shared and/or other service bureau, computing service, and/or “server farm.”

The terms “determine,” “calculate,” and “compute,” and variations thereof, as used herein, are used interchangeably and include any type of methodology, process, mathematical operation, or technique.

A “lock” is a mechanical or electronic or electromechanical fastening device that can be released by a physical object (such as a key, keycard, fingerprint, RFID card, security token, coin etc.), by supplying secret information (such as a number or letter permutation or password), or by a combination thereof.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

The term “Quick Response code” or “QR code” refers to a matrix barcode (or two-dimensional barcode) that is a machine-readable optical label containing information about with an item to which it is attached or on which it is displayed or associated with a person having the item. A QR code uses four standardized encoding modes (numeric, alphanumeric, byte/binary, and kanji) to store data efficiently; extensions may also be used. For example, QR codes may store personal information, URL's, product pricing, bank account information, credit card information, website login information, and WiFi login information.

The term “Radio-Frequency identification” or “RFID” refers to an identifier that uses electromagnetic fields to automatically identify and track tags attached to objects. The tags contain electronically-stored information. Passive tags collect energy from a nearby RFID reader's interrogating radio waves. Active tags have a local power source (such as a battery) and may operate hundreds of meters from the RFID reader. Unlike a barcode, the tag need not be within the line of sight of the reader, so it may be embedded in the tracked object. RFID is one method of automatic identification and data capture (AIDC). Tags may either be read-only, having a factory-assigned serial number that is used as a key into a database, or may be read/write, where object-specific data can be written into the tag by the system user. Field programmable tags may be write-once, read-multiple; “blank” tags may be written with an electronic product code by the user. RFID tags contain at least three parts: an integrated circuit that stores and processes information and that modulates and demodulates radio-frequency (RF) signals; a means of collecting DC power from the incident reader signal; and an antenna for receiving and transmitting the signal. The tag information is stored in a non-volatile memory. The RFID tag includes either fixed or programmable logic for processing the transmission and sensor data, respectively. An RFID reader transmits an encoded radio signal to interrogate the tag. The RFID tag receives the message and then responds with its identification and other information. This may be only a unique tag serial number, or may be product-related information such as a stock number, lot or batch number, production date, or other specific information. Since tags have individual serial numbers, the RFID system design can discriminate among several tags that might be within the range of the RFID reader and read them simultaneously.

The term “barcode” refers to an optical, machine-readable representation of data; the data usually describes something about the object that carries or displays the barcode or a person associated with the object. Traditional barcodes systematically represent data by varying the widths and spacings of parallel lines and may be referred to as linear or one-dimensional (1D). Two-dimensional (2D) barcodes use rectangles, dots, hexagons and other geometric patterns, (also called matrix codes). Barcodes can be scanned by special optical scanners called barcode readers or by application software that can read images, such as smartphones with cameras.

The terms “configured for,” “configured to” and conjugations thereof, as used herein with respect to a specified operation or function, refer to a device, component, circuit, structure, machine, signal, etc., that is physically or virtually constructed, programmed, formatted and/or arranged to perform the specified operation or function.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a vessel configured to be moved during transport of an item contained within a containment area of the vessel;
a sensor configured to produce sensor data that characterizes an environment proximate to the containment area; and
at least one processor configured to:
determine an event occurrence based on the sensor data; and
send a notification to a device over a network in response to the event occurrence.

2. The system of claim 1, wherein the event occurrence is at least one of: the sensor data indicating an unauthorized access to the environment, the sensor data being outside of a nominal range, and the sensor data indicating mishandling of the vessel.

3. The system of claim 1, further comprising:
a lock configured to be opened or closed to provide access to the containment area, wherein the at least one processor is further configured to open or close the lock based on the sensor data.

4. The system of claim 3, wherein the sensor data reflects a predetermined access code configured to unlock the vessel.

5. The system of claim 4, wherein the predetermined access code characterizes a signal received from a mobile device.

6. The system of claim 3, wherein the sensor data is location data and the at least one processor is further configured to open the lock when the location data matches a predetermined destination.

7. The system of claim 1, wherein the at least one processor is communicatively coupled to a datastore, wherein the at least one processor is further configured to record, in the datastore, a series of timestamps at different times associated with a custodian for the secure receptacle based on the sensor data.

8. The system of claim 1, wherein the at least one processor is further configured to determine a custodian of the vessel during the event occurrence.

9. The system of claim 1, wherein the sensor is part of the vessel.

10. The system of claim 1, wherein the sensor is separate from the vessel.

11. The system of claim 1, wherein:
the sensor data characterizes a geographic location of the containment area, and
the at least one processor is further configured to determine the event occurrence as the geographic location of the containment area matching a reference geographic location.

12. A method, comprising:
receiving, from a sensor, sensor data that characterizes an environment proximate to a containment area of a vessel, wherein the vessel is configured to be moved during transport of an item located within the containment area;
determining an event occurrence based on the sensor data;
determining a custodian of the vessel during the event occurrence; and
sending a notification indicating the custodian to a device over a network in response to the event occurrence.

13. The method of claim 12, further comprising:
determining the event occurrence based on a parameter value meeting a threshold value, wherein the parameter value is based on the sensor data.

14. The method of claim 12, further comprising:
determining the custodian of the vessel based on a parameter value meeting a threshold value, wherein the parameter value is based on the sensor data.

15. The method of claim 12, further comprising wirelessly communicating with the sensor over the network.

16. The method of claim 12, wherein the item is a food item.

17. A non-transitory computer readable medium having instructions stored thereon, wherein the instructions, when executed by a processor, cause a device to perform operations comprising:
receiving, from a sensor, sensor data that characterizes an environment proximate to a containment area of a vessel, wherein the vessel is configured to be moved during transport of an item located within the containment area;
determining an event occurrence based on the sensor data; and
determining a custodian of the vessel during the event occurrence.

18. The non-transitory computer readable medium of claim 17, wherein the sensor data characterizes the item while located within the containment area.

19. The non-transitory computer readable medium of claim 17, wherein the sensor is at least one of: a keypad, a shock sensor, a temperature sensor, an infrared sensor, a resistance sensor, a humidity sensor, an accelerometer, a tamper sensor, a location sensor, and a user interface sensor.

20. The non-transitory computer readable medium of claim 17, wherein the sensor comprises a resistance sensor connected with a mesh within the vessel, wherein the sensor data is a resistance along the mesh.

21. The non-transitory computer readable medium of claim 17, wherein the sensor is connected to a power source on the vessel.

22. A secure vessel, comprising:
a containment area;
a sensor configured to produce sensor data that characterizes an environment proximate to the containment area, wherein the containment area is configured to be moved during transport of an item contained within the containment area; and
at least one processor configured to:
determine an event occurrence based on the sensor data; and
send a notification to a device over a network in response to the event occurrence.

23. The secure vessel of claim 22, further comprising:
a battery; and
a docking port configured to interface with a charging mat to transfer power from the charging mat to the battery.

24. The secure vessel of claim 22, further comprising:
a lock configured to be opened or closed to provide access to the containment area, wherein the at least one processor is further configured to open or close the lock based on the sensor data.

25. The secure vessel of claim 24, wherein the sensor data reflects a predetermined access code configured to unlock the secure vessel.

26. The secure vessel of claim 25, wherein the predetermined access code characterizes a signal received from a mobile device.

27. A method performed by a secure vessel, comprising:
receiving, from a sensor at the secure vessel, sensor data that characterizes an environment proximate to a containment area of the secure vessel, wherein the vessel is configured to be moved during transport of an item located within the containment area;
determining an event occurrence based on the sensor data;
determining a custodian of the vessel during the event occurrence; and
sending a notification indicating the custodian to a device over a network in response to the event occurrence.

28. The method of claim 27, further comprising:
determining the event occurrence based on a parameter value meeting a threshold value, wherein the parameter value is based on the sensor data.

29. The method of claim 27, further comprising:
determining the custodian of the vessel based on a parameter value meeting a threshold value, wherein the parameter value is based on the sensor data.

30. The method of claim 27, further comprising wirelessly communicating with the sensor over the network.

31. A customer device, comprising:
at least one processor configured to:
send an order for an item to a source;
receive a notification characterizing an event occurrence, wherein the event occurrence is based on sensor data that characterizes an environment proximate to a containment area of a secure vessel configured to be moved during transport of the item contained within the containment area;
present an alert via a user interface in response to receiving the notification; and
receive an instruction via the user interface in response to receiving the notification.

32. The customer device of claim 31, wherein the instruction is to cancel or replace the order.

33. The customer device of claim 31, further comprising:
a lock configured to be opened or closed to provide access to the containment area, wherein the at least one processor is further configured to open or close the lock based on the sensor data.

34. The customer device of claim 33, wherein the sensor data is location data and the at least one processor is further configured to open the lock when the location data matches a predetermined destination.

35. The customer device of claim 31, wherein the at least one processor is communicatively coupled to a datastore, wherein the at least one processor is further configured to record, in the datastore, a series of timestamps at different times associated with a custodian for the secure receptacle based on the sensor data.

36. The customer device of claim 31, wherein the at least one processor is further configured to determine a custodian of the vessel during the event occurrence.

37. A method performed by a customer device, comprising:
sending an order for an item to a source;
receiving a notification characterizing an event occurrence, wherein the event occurrence is based on sensor data that characterizes an environment proximate to a containment area of a secure vessel configured to be moved during transport of the item contained within the containment area;
presenting an alert via a user interface in response to receiving the notification; and
receiving an instruction via the user interface in response to receiving the notification.

38. The method of claim 37, wherein the instruction is to cancel or replace the order.

39. The method of claim 37, wherein the sensor data characterizes the item while located within the containment area.

40. The method of claim 37, wherein the sensor data is produced by a sensor that is at least one of: a keypad, a shock sensor, a temperature sensor, an infrared sensor, a resistance sensor, a humidity sensor, an accelerometer, a tamper sensor, a location sensor, and a user interface sensor.

41. The method of claim 37, wherein the sensor comprises a resistance sensor connected with a mesh within the vessel, wherein the sensor data is a resistance along the mesh.

42. The method of claim 37, wherein the sensor is connected to a power source on the vessel.

43. A source device, comprising:
at least one processor configured to:
receive an order for an item from a customer;
send a message to a courier to deliver the item based on the order;
receive a notification characterizing an event occurrence, wherein the event occurrence is based on sensor data that characterizes an environment proximate to a containment area of a secure vessel configured to be moved during transport of the item contained within the containment area; and
receive an instruction in response to receiving the notification.

44. The source device of claim 43, wherein the instruction is to cancel or replace the order.

45. The source device of claim 43, wherein the event occurrence is at least one of: the sensor data indicating an unauthorized access to the environment, the sensor data being outside of a nominal range, and the sensor data indicating mishandling of the vessel.

46. The source device of claim 43, wherein the sensor is part of the vessel.

47. The source device of claim 43, wherein the sensor is separate from the vessel.

48. The source device of claim 43, wherein the item is a drug item.

49. A method, comprising:
receiving an order for an item from a customer;
sending a message to a courier to deliver the item based on the order;
receiving a notification characterizing an event occurrence, wherein the event occurrence is based on sensor data that characterizes an environment proximate to a containment area of a secure vessel configured to be moved during transport of the item contained within the containment area; and
receiving an instruction in response to receiving the notification.

50. The method of claim 49, wherein the instruction is to cancel or replace the order.

51. The method of claim 49, further comprising:
opening or closing a lock based on the sensor data.

52. The method of claim 49, further comprising:
opening a lock based on the sensor data matching a predetermined location.

53. The method of claim 49, further comprising:
determining the event occurrence based on a parameter value meeting a threshold value, wherein the parameter value is based on the sensor data.

54. The method of claim 49, further comprising:
determining a custodian of the vessel based on a parameter value meeting a threshold value, wherein the parameter value is based on the sensor data.
